(19) United States
(12) Patent Application Publication
(10) Pub. No.: US 2013/0199385 A1
(43) Pub. Date: Aug. 8, 2013

(54) AUTOMATED HEAT TRANSFER PRESS

(71) Applicant: Stahls' Inc., St. Clair Shores, MI (US)

(72) Inventors: Benjamin B. Robinson, Smithfield, PA (US); Michael Bendis, Uniontown, PA (US); Paul Tomlinson, Masontown, PA (US)

(73) Assignee: Stahls' Inc., St. Clair Shores, MI (US)

(21) Appl. No.: 13/761,901

(22) Filed: Feb. 7, 2013

Related U.S. Application Data
(60) Provisional application No. 61/595,793, filed on Feb. 7, 2012.

(51) Int. Cl. B30B 7/02; B30B 15/06; B30B 9/00

(52) U.S. Cl. CPC B30B 7/02; B30B 9/00; B30B 15/06
USPC 100/226; 100/214; 100/269.01

(57) ABSTRACT

Exemplary presses, e.g., for applying indicia to garments by application of heat, are disclosed. For example, a press may include an upper platen, and a lower platen disposed below and generally aligned with the upper platen. The press may further include a support head adapted to move the upper platen between an open position, wherein the upper and lower platens are spaced away from one another, and a closed position, wherein the upper platen is pressed against the lower platen. In some exemplary approaches, the support head may extend from an axial support of the press. The support head may be configured to rotate about the axial support while maintaining the platens in a parallel alignment with one another as the support head rotates about the axial support. In some examples, the operation of the press is generally automated.

### CROSS-REFERENCE TO RELATED APPLICATION

This application claims priority to U.S. Provisional Patent Application Ser. No. 61/595,793, filed on Feb. 7, 2012, entitled AUTOMATED HEAT TRANSFER PRESS, the contents of which are hereby expressly incorporated by reference in their entirety.

### TECHNICAL FIELD

The exemplary illustrations described herein are generally directed to presses, such as heat transfer presses that include platens.

### BACKGROUND

Heat applied transfers include a variety of indicia with inks, material layers, and adhesives that become bonded to material layers, for example, apparel such as shirts, jackets, or the like, upon pressurized contact and heating of the transfers and apparel between press platens. Graphic images and lettering may generally be accurately and quickly transferred to the apparel without bleeding or partial interruptions in the bonding of the transfer, as long as the presses can be operated at a predetermined temperature for a predetermined time and at a predetermined pressure.

The presses must be able to accommodate many variations in the arrangement of transfers and apparel, as well as the types of transfers and apparel materials available. Moreover, the presses must accommodate a wide variety of temperatures, pressures, and time intervals associated with application of indicia to a garment. Due to the need for flexibility and economic factors, presses have traditionally been manually operated, i.e., they rely on a user (e.g., an operator) to control at least (a) the force applied through the platens and (b) the length of time the force is applied with a mechanical apparatus.

The accuracy and precision of the temperature, the pressure and the time duration for which these parameters are applied to the transfers are particularly important to complete an efficient bonding of the transfers to materials, and are difficult to accomplish in an accurate and repeatable manner. In particular, depending upon materials and the structure of the indicia to be applied to the apparel, indicia may be subject to inconsistent application conditions throughout the surface of apparel to which the transfer is applied. For example, the application of excessive pressure between the platen pressing surfaces may cause bleeding of the colors, while insufficient pressure may result in blotched or unattached areas where the indicia failed to adhere completely to the garment.

Some basic controls have been employed more recently in some presses, e.g., a timer or sensor to detect an amount of time or magnitude of an applied force, respectively. However, these controls have not solved the essential difficulty of controlling the time or pressure under which heat is actually applied to a garment. For example, difficulties in adjusting timing or pressure settings tends to encourage operators to avoid adjustments even for garments where such adjustments are critical, e.g., between stages of a process where different pressures or timing is needed. Additionally, press operators may tend to go by their “feel”, given their experience, to apply an appropriate amount of pressure. Moreover, there is often a lack of consistency with the same press operator, let alone differences between different presses and press operators.

Accordingly, there is a need in the art for an improved press for applying a platen to adhere graphic images or foils to textiles or substrates with a more consistent and repeatable force that facilitates easy adjustments. Additionally, there is a need for an improved press that applies a given force accurately over multiple time intervals. Moreover, there is a need for an improved press that allows accurate application of a force and/or time interval, while also allowing variation of the force and/or time.

### BRIEF DESCRIPTION OF THE DRAWINGS

While the claims are not limited to the illustrated embodiments, an appreciation of various aspects is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows.

FIG. 1A is a lateral perspective view of an exemplary press;

FIG. 1B is a lateral perspective view of the press shown in FIG. 1A, with the support head rotated away from the lower platen;

FIG. 2 is a partial cutaway perspective view of the support head of the press shown in FIGS. 1A and 1B; and

FIGS. 3A-3E are exemplary views of a menu screens from a display, e.g., as shown in the exemplary press of FIGS. 1A, 1B, and 2.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

Various exemplary illustrations are provided herein of exemplary presses, e.g., for applying indicia to garments by application of heat. According to one exemplary illustration, a press may include an upper platen, and a lower platen disposed below and generally aligned with the upper platen. The press may further include a support head adapted to move the upper platen between an open position, wherein the upper and lower platens are spaced away from one another, and a closed position, wherein the upper platen is pressed against the lower platen. In some exemplary approaches, the support head may extend from an axial support of the press. The support head may be configured to rotate about the axial support while maintaining the platens in a parallel alignment with one another as the support head rotates about the axial support.

The support head may further include a controller in communication with the support head, wherein the controller is configured to apply the upper platen against the lower platen with one of a predetermined time and a predetermined force. Accordingly, the press may generally provide automated application of indicia to garments. Moreover, in some examples the controller may include a memory storing a plurality of application programs, where each of the application programs include a plurality of predetermined application times and a plurality of associated application pressures. The press may thereby generally facilitate application of indicia to garments in a multi-step process that is generally effected by the controller, and without the need for intervention by an operator.

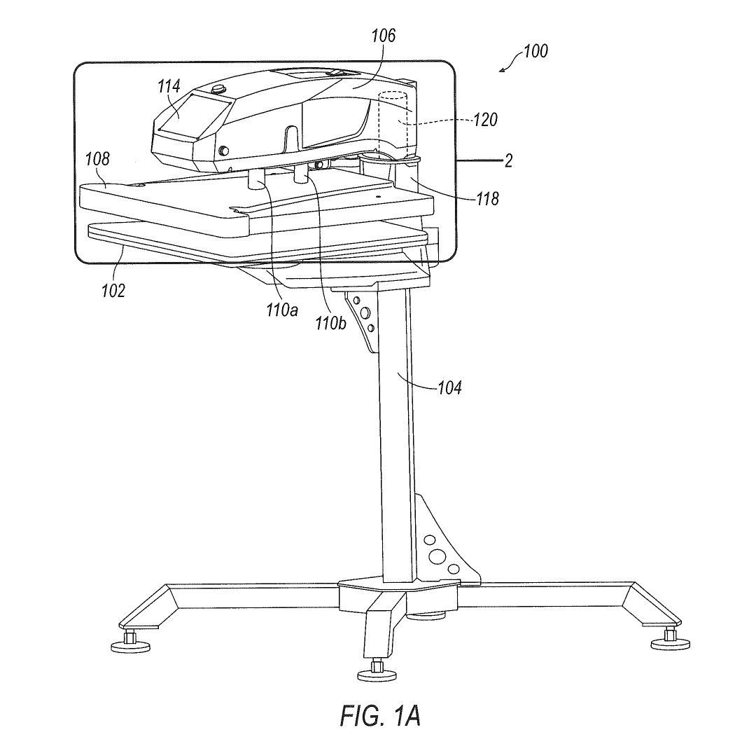

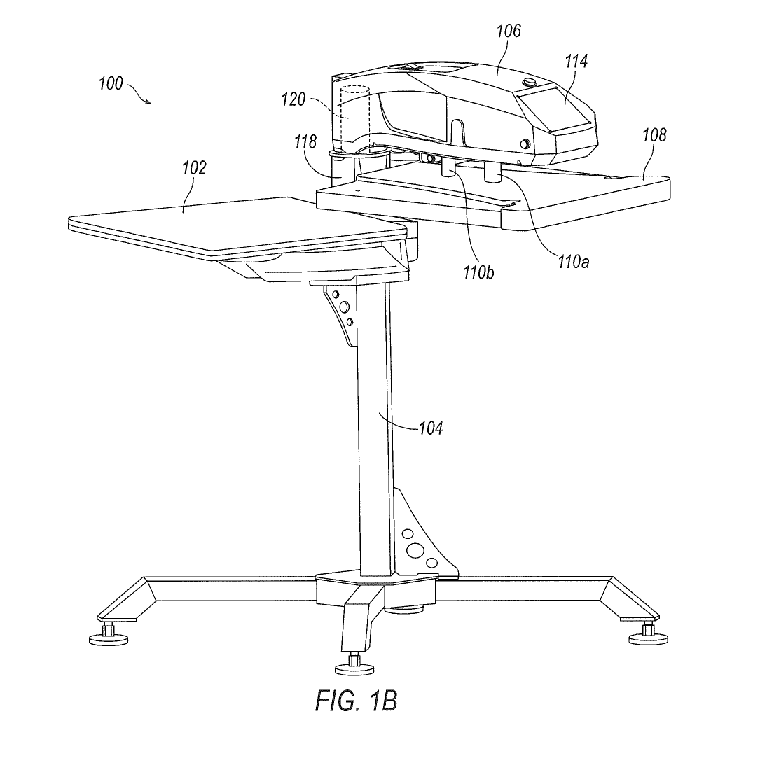

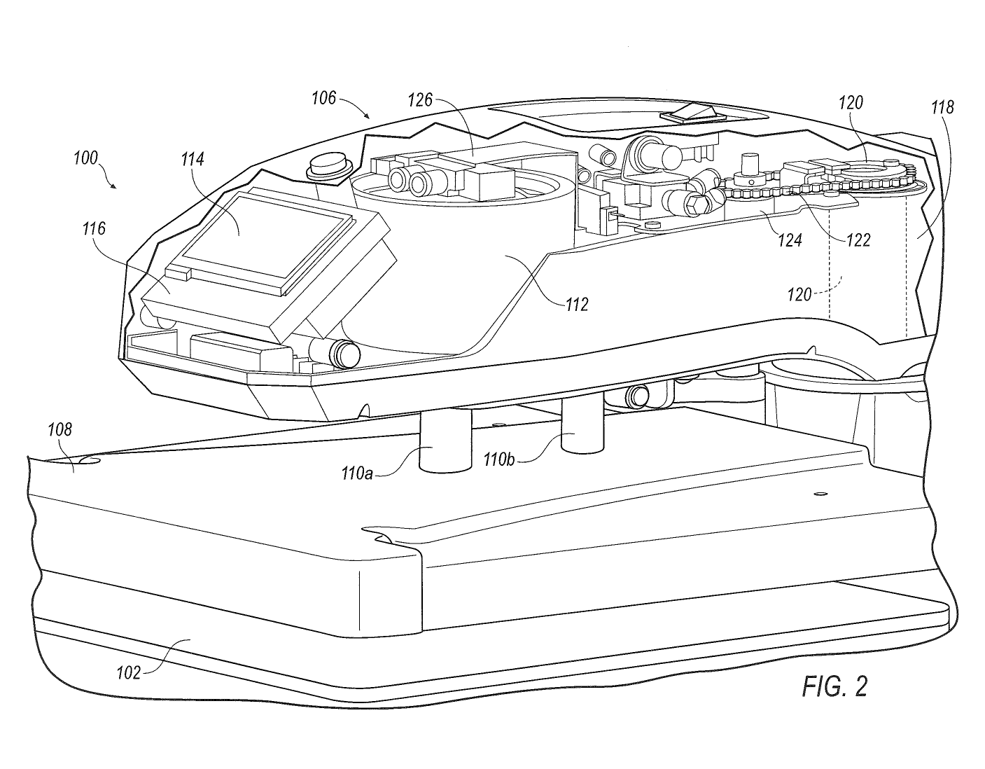

Referring now to FIGS. 1A, 1B, and 2, an exemplary heat applied transfer press 100 is shown. The press includes a lower platen 102 mounted on a stand 104 or base frame, and a support head 106 supporting an upper platen 108 above the lower platen. Force may be applied to upper platen 108 through a pair of shafts 110a, 110b. The mechanism for displacing the upper platen to impart a force to the lower platen may include a pneumatic pressure chamber 112. In one example, the platens 102, 108 may include a work structure of a machine tool and a generally flat plate of a press configured to press a material, e.g., a garment, to allow placement of indicia on the garment.

The support head 106 may position the upper platen 108 in a substantially parallel alignment with the lower platen 102 as it approaches a closed position, e.g., as best seen in FIG. 1A. Moreover, the closed position of the upper platen 108 can be varied, e.g., to raise the level of upper platen 108 with respect to lower platen. As a result, regardless of the thickness of the material, the transfers to be applied, or the thickness of the support pads to be used between the upper and lower platens, the alignment of the platens 102, 108 avoids uneven pinching of the material and the transfers positioned between upper and lower platens. Moreover, pads (not shown) may also assist the pressure distribution regardless of irregularities in the thicknesses of the heat applied transfers and the apparel to which it is applied.

At least one of the platens, e.g., the upper platen 108, includes a heating element (not shown) such as conventional resistive heating elements and the like, which may be formed as serpentine or otherwise wound throughout the surface area of upper platen. The heating element is coupled to a typical power supply through a switch and/or the controller, and may be configured for adjusting the temperature of the heating element, e.g., by way of the controller. Further, the temperature of the heating element may be adjusted at a visual display 114 which interfaces with a controller 116, as best seen in FIG. 2. The upper platen 108 may also carry a thermo-couple sensor (not shown) which is wired in a conventional manner to generate temperature information for the controller 116, which may display such information via the display 114. The display 114 may thus be mounted for exposure to the area occupied by the press operator as typically positioned for manipulating and controlling the press, e.g., as best seen in FIG. 1A. The electrical circuit for the heating element may also include a temperature control such as a thermostat.

The controller 116 may generally include computational and control elements (e.g., a microprocessor or a microcontroller). The controller 116 may generally provide time monitoring, temperature monitoring, pressure monitoring, and control. The display 114 may further include various readout displays, e.g., to allow display of a force, temperature, or time associated with operation of the press. Moreover, the display may allow for manipulation of the controller by a user, e.g., by way of a touchscreen interface. The display may thereby be used by the operator to adjust an amount of force applied by the upper platen 108 to the lower platen 102, a cycle time for the force to be applied, and a temperature of the heated platen(s).

As described in detail in the attached functional description (See Attachments A and B), the controller 116 may facilitate a variety of user-customized settings for use of the press. In one exemplary illustration, the controller 116 includes a memory for storing one or more programs associated with the application of an indicia to a garment, including a predetermined temperature, a predetermined force, and/or a predetermined cycle time associated with the upper platen. In another exemplary illustration, the programs may include a plurality of stages in the application process, e.g., where the upper platen 108 is applied to a garment with a first pressure that is applied to a garment for a first cycle time, and a second pressure that is subsequently applied for a second cycle time. In some examples, the pressure and cycle time are different, such that a variety of different pressures and cycle times may be applied by the press.

As noted above, the support head 106 generally supports and aligns the upper platen 108 with respect to the lower platen 102. The support head 106 may also be pivotable about an axial support 118, as best seen in FIG. 2, away from the lower platen, to allow placement of a garment upon the lower platen. More specifically, the support head may generally pivot about a pivot shaft 120 disposed within the axial support. The support head 106 may include a drive chain 122 or belt which is rotated by a motor 124 disposed within the support head, thereby rotating the support head 106 about the pivot shaft 120. The motor 124 may be controlled by way of the controller 116.

As briefly described above, a pressure chamber 112 may be employed to selectively move the upper platen 108 with respect to the lower platen 102, thereby selectively imparting a force against the lower platen 102. The pressure chamber 112 may be controlled by any pressure regulating device that is convenient. In one example, and as best seen in FIG. 2, an electric pressure (EP) Regulator 126 in communication with the controller and the pressure chamber may facilitate movement of the shaft(s) of the upper platen. In one exemplary illustration, the EP regulator 126 is an SMC ITV 1050 regulator.

The various components that facilitate automated operation of the press 100 may generally be integrated into the support head 106. For example, as described above the support head may include therein the display 114, controller 116, pressure chamber 112, motor 124, and drive belt 122. Accordingly, the support head 106 may generally house the main components of the press 100 that provide automated operation of the press 100.

In one exemplary illustration, the controller 116 is a Freescale i/MX processor. The processing power available in this exemplary ARM920 based architecture of the i/MX may generally communicate with the display 114, e.g., a color LCD touchscreen. Accordingly, the controller 116 may generally control heating, setting and monitoring of the application pressure, monitoring system health, interpreting touchscreen inputs, and optimizing system operation, all while supervising numerous other system operations simultaneously.

As noted above, the control system may include a memory, e.g., included with controller 116, having the ability to store a large number of application programs. In one example, over 1000 application programs or “recipes” may be stored, each with individual control of, for example, four (4) sub-steps, each with varying pressure and dwell or cycle times. Accordingly, setup time is reduced and consistency is improved, since it effectively eliminates human error. More specifically, by automatically setting and monitoring the pressure during each step, e.g., as supplied by the pressure chamber 112, the operator generally does not have to worry about varying fluctuations in a power supply to the support head. Moreover, the pressure chamber 112 also removes one source of potential error as a result of any inconsistent pressure supplied by the operator. In one exemplary illustration, an air compressor (not shown in FIGS. 1A, 1B, and 2) may be used to supply compressed air to the pressure chamber, which is used to manipulate the upper platen 108 downward against the lower platen 102, e.g., to apply heat to a garment/indicia assembly. The controller 116 may automatically compensate for any changes or inconsistencies in the air supply to the pressure chamber 112, and it may also alert the operator of any problems, e.g., insufficient, or total loss of supplied air pressure. Operator fatigue is also significantly reduced by eliminating the stress of constantly adjusting the press to provide the proper pressure, e.g., via pressure valves or levers, since the only inputs to the press 100 are generally via the touchscreen display 114.

As noted above, the controller 116 may be configured to pivot the support head 106 about the axial support 118. Accordingly, the operation of the press 100 may be integrated with the pivoting of the support head 106 before and/or after the upper platen 108 is forced against the lower platen 102. The ability to apply the upper platen 108 for a predetermined pressure and time may thus be combined with the ability to retract and swing the support head 106 out of the way in a synchronous fashion. The time saved in each print may only be seconds, but in a continuous operation, these seconds quickly multiply into saved hours associated with every job. Moreover, operator fatigue is further reduced by eliminating the need to manipulate the press manually.

The controller 116 may also include a standardized interface (not shown) to allow for system upgrades in the field, e.g., a USB interface. The controller 116 may also allow for multiple levels of user access, e.g., to allow setting limits on a maximum pressure or temperature to be provided by the platen(s). Finally, the controller 116 may also be supplied power via a universal A/C input range of 100-240 VAC at 50/60 Hz.

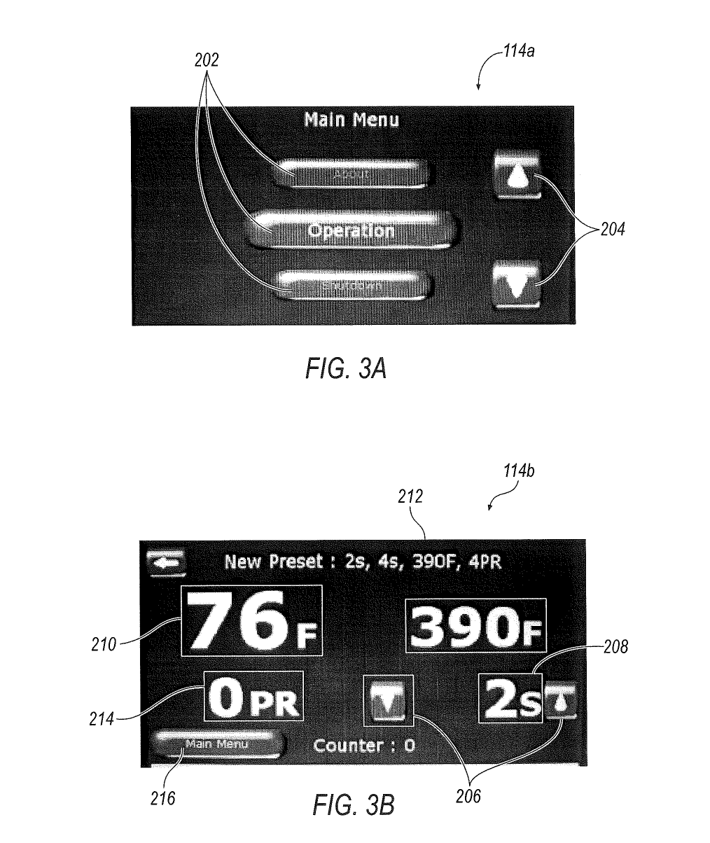

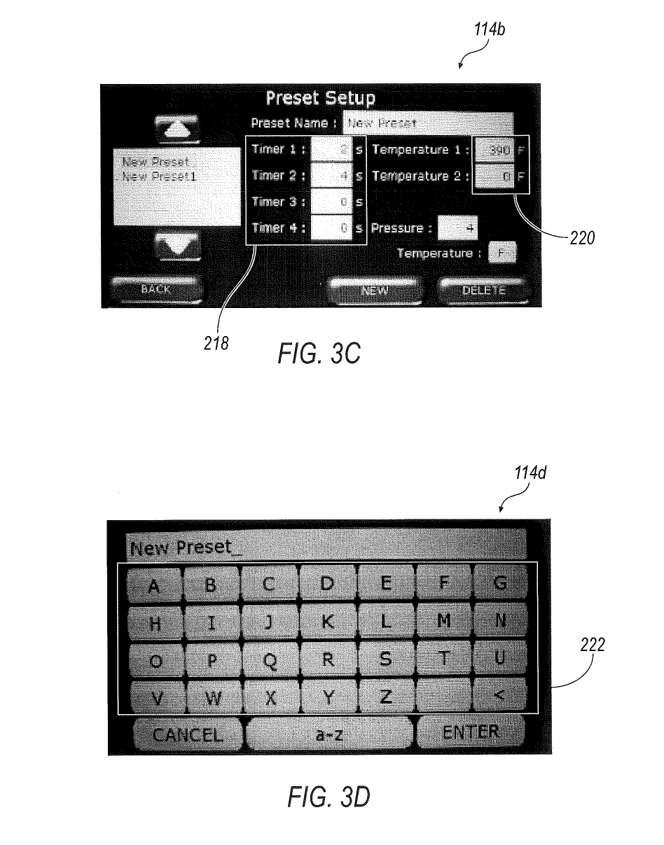

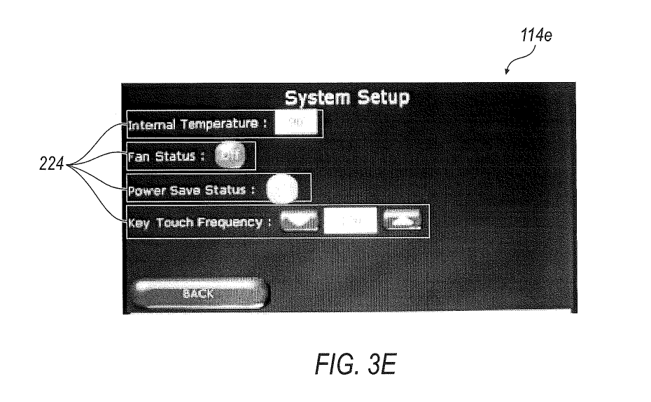

Turning now to FIGS. 3A-3E, exemplary menu screens associated with the display 114 are illustrated. As noted above, the display 114 may be employed to select various temperatures, times, forces, etc. as part of a plurality of selectable programs that may be executed by the press 100. The display 114 may be in communication with the controller 116. Generally the display 114 and controller 116 facilitate scrollable vertical menus that are displayed on the display 114 for access to functions of the press 100, examples of which are illustrated in FIGS. 3A-3E. For example, as shown in FIG. 3A, a main menu screen 114a includes selectable buttons 202 and arrows 204 for initiating an operating mode of the press 100. A main operating screen 114b, as illustrated in FIG. 3B, may provide an “Actual Temperature” reading 210 and an “Actual Pressure” reading 214 associated with the platens 102, 108. A “Target Temperature” reading 212 and/or “Target Pressure” reading (not shown in FIG. 3B) associated with the platens 102, 108 may also be shown, as well as a timer indicator 208 and selectable arrows 206 for increasing or decreasing the timer setting. Moreover, a selectable “Main Menu” button 216 may be provided for exiting to the main menu screen 114a.

Accordingly, the platens 102, 108 may be programmed via the display 114 to maintain a closed position for a predetermined time. Additionally, the press 100 may cycle through multiple “hits” of the press 100, where the upper platen 108 is closed against the lower platen 102, opened, and then closed again. Moreover, these settings may be selected from stored “Presets” that may be modified by a user, e.g., at a Preset Setup screen 114c as illustrated in FIG. 3C. The Preset Setup screen 114c may display a Preset Name, as well as any Timer, Temperature and/or Platen Pressure settings for the preset. For example, the Preset Setup screen 114c may include a plurality of timer fields 218 denoting time delays associated with maintaining a closed or open position of the platens 102, 108. Additionally, each timer step may include varying temperatures that are provided in temperature fields 220. For example, a preset may include a first closure of the press for a first hold time of 20 seconds at a first temperature of 360 degrees Fahrenheit, and a second closure for a second hold time of 40 seconds at a same or different temperature. Moreover, each of the first and second closures may employ a same or different platen pressure.

Data entry may generally be accomplished in any one of the menu fields with a touch panel keyboard screen 114d comprising touchscreen letters 222, as illustrated in FIG. 3D. A System Setup screen 114e may generally allow for modifying various operating parameters of the press, e.g., as illustrated in the parameter fields 224. For example, a power save mode, a fan shutoff, an internal temperature limit, or any other operating parameter that is convenient may be provided.

The exemplary illustrations are not limited to the previously described examples. Rather, a plurality of variants and modifications are possible, which also make use of the ideas of the exemplary illustrations and therefore fall within the protective scope. Accordingly, it is to be understood that the above description is intended to be illustrative and not restrictive.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “the,” etc. should be read to recite one or more of the indicated elements unless a claim recites an explicit limitation to the contrary.

1. A press, comprising:
an upper platen;
a lower platen disposed below and generally aligned with the upper platen;
a support head adapted to move the upper platen between an open position, wherein the upper and lower platens are spaced away from one another, and a closed position, wherein the upper platen is pressed against the lower platen; and
a controller in communication with the support head, the controller configured to apply the upper platen against the lower platen with one of a predetermined time and a predetermined force.

2. The press of claim 1, wherein the support head extends from an axial support, the support head configured to rotate about the axial support, wherein the platens are aligned parallel to one another as the support head rotates about the axial support.

3. The press of claim 2, wherein the support head includes a motor configured to rotate the support head about the axial support.

4. The press of claim 3, wherein the controller is configured to selectively activate the motor to rotate the support head about the axial support.

5. The press of claim 3, wherein the support head includes a drive belt connected to the motor.

6. The press of claim 1, wherein the controller is configured to apply the upper platen against the lower platen with the other of a predetermined time and a predetermined force.

7. The press of claim 6, wherein the controller includes a memory configured to store a plurality of application programs, each of the application programs including a plurality of predetermined application times and a plurality of associated application pressures.

8. The press of claim 7, further comprising a display positioned on the support head, the display configured to allow selection of one of the application programs.

9. The press of claim 1, wherein the support head includes a pneumatic cylinder configured to apply a pressure against the lower platen with the upper platen.

10. A press, comprising:
an upper platen;
a lower platen disposed below and generally aligned with the upper platen;
a support head adapted to move the upper platen between an open position, wherein the upper and lower platens are spaced away from one another, and a closed position, wherein the upper platen is pressed against the lower platen; and
a controller in communication with the support head, the controller configured to apply the upper platen against the lower platen;
wherein the support head extends from an axial support, the support head configured to rotate about the axial support, wherein the platens are aligned parallel to one another as the support head rotates about the axial support.

11. The press of claim 10, wherein the support head includes a motor configured to rotate the support head about the axial support.

12. The press of claim 11, wherein the controller is configured to selectively activate the motor to rotate the support head about the axial support.

13. The press of claim 11, wherein the support head includes a drive belt connected to the motor.

14. The press of claim 10, wherein the controller includes a memory configured to store a plurality of application programs, each of the application programs including a plurality of predetermined application times and a plurality of associated application pressures.

15. The press of claim 14, further comprising a display positioned on the support head, the display configured to allow selection of one of the application programs.

16. The press of claim 10, wherein the support head includes a pneumatic cylinder configured to apply a pressure against the lower platen with the upper platen.

17. A press, comprising:
an upper platen;
a lower platen disposed below and generally aligned with the upper platen;
a support head adapted to move the upper platen between an open position, wherein the upper and lower platens are spaced away from one another, and a closed position, wherein the upper platen is pressed against the lower platen; and
a controller in communication with the support head, the controller configured to apply the upper platen against the lower platen;
wherein the controller includes a memory configured to store a plurality of application programs, each of the application programs including a plurality of predetermined application times and a plurality of associated application pressures.

18. The press of claim 17, wherein the support head includes a motor configured to rotate the support head about the axial support.

19. The press of claim 18, wherein the controller is configured to selectively activate the motor to rotate the support head about the axial support.

20. The press of claim 17, further comprising a display positioned on the support head, the display configured to allow selection of one of the application programs.
